(19) United States
(12) Patent Application Publication
(10) Pub. No.: US 2007/0149206 A1
(43) Pub. Date: Jun. 28, 2007

(54) METHOD AND SYSTEM FOR ADJUSTING UPLINK TRANSMISSION TIMING FOR LONG TERM EVOLUTION HANDOVER

(75) Inventors: Jin Wang, Central Islip, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/612,837

(22) Filed: Dec. 19, 2006

Related U.S. Application Data
(60) Provisional application No. 60/753,124, filed on Dec. 22, 2005.
(60) Provisional application No. 60/839,267, filed on Aug. 21, 2006.

(51) Int. Cl. H04Q 7/20

(52) U.S. Cl. 455/450; 455/502

(57) ABSTRACT

A method and system for adjusting uplink transmission timing when sending an initial transmission to a target cell/Node-B of an evolved universal terrestrial radio access network (E-UTRAN) immediately after handover from a source cell/Node-B of the E-UTRAN. In one embodiment, a user equipment (UE) autonomously computes and applies a timing advance (TA) value based on the current source cell/Node-B timing value, cell/Node-B beacon channel reference signal measurements and knowledge of the relative time difference, (if any), between the source and target cells/Node-Bs. In another embodiment, the UE sends a scheduling request message or real data packets with the computed TA value applied to the uplink transmission timing to the E-UTRAN via pre-allocated non-contention based uplink radio resources. In an alternate embodiment, the UE sends a scheduling request message with the new computed TA value applied to the UL transmission timing to an E-UTRAN via a synchronous random access channel (RACH).

### CROSS REFERENCE TO RELATED APPLICATIONS

This application claims the benefit of U.S. Provisional Application No. 60/753,124 filed Dec. 22, 2005 and U.S. Provisional Application No. 60/839,267 filed Aug. 21, 2006, which are incorporated by reference as if fully set forth.

### FIELD OF INVENTION

The present invention relates to wireless communication systems. More particularly, the present invention is related to a timing adjustment procedure for synchronizing data transmissions between a wireless transmit/receive unit (WTRU), (i.e., a user equipment (UE)), and a target cell/evolved Node-B (eNB) immediately after handover from a source cell/eNB to the target cell/eNB in a long term evolution (LTE) system.

### BACKGROUND

The objective of evolved universal terrestrial radio access (E-UTRA) and evolved universal terrestrial radio access network (E-UTRAN) is to develop a radio access network (RAN) for providing a high-data-rate, low-latency and packet-optimized improved system capacity and coverage. FIG. 1 shows a wireless communication system 100 which includes at least one cell/Node-B 105 that communicates with at least one UE 110. In order to achieve this objective, an evolution of the radio interface as well as the radio network architecture is being considered, such as a long term evolution (LTE) system. However, there are no existing dedicated channels in an LTE system, so all services are provided over shared and common channels. Furthermore, system frame number-system frame number (SFN-SFN) measurements may not be available in the LTE system. This causes problems with synchronized communications between the UE 110 and the cell/Node-B 105 during handover in the LTE system.

A timing advance (TA) enables the UE 110 to send its uplink (UL) bursts earlier than what the UE 110 perceives at the start of an UL timeslot for transmission, so that the UL bursts are received at the cell/Node-B 105 within a time window that allows accurate detection and minimizes, or eliminates, signal degradation. Single channel frequency division multiple access (SC-FDMA) is a new radio access technology that has a stringent performance requirement for UL synchronization. Thus, an appropriate and accurate TA is critical in LTE UL transmission.

Handover requires that TA be adjusted for the LYE 110 in the case where the UE 110 maintains shared channel connectivity or use of the synchronous PRACH in a target cell/Node-B with minimum delay which is especially important for time sensitive services such as voice over IP (VoIP) and interactive gaming, etc. The LTE system should avoid requiring an asynchronous random access channel (RACH) access burst to establish the TA during handover since this procedure increases the delay in establishing a connection in the target cell and is not an efficient use of physical resources relative to use of an UL shared channel. In the Third Generation Partnership Project (3GPP), TA during handover is achieved through measuring SFN-SFN timing difference between old and new radio links associated with old and new Node-Bs. However, in an LTE system, there is no new radio link set in parallel to the old radio link during handover, and an SFN-SFN for timing difference measurement may not exist. Thus, acquiring TA with less delay is desired during handover in an LTE system.

TA is very important in SC-FDMA systems to achieve the acceptable performance requirement. This becomes a problem during handover, as the UE 110 has to achieve fast synchronized communications with the cell/Node-B 105 after a network commanded handover is implemented, and the UE 110 has to achieve fast cell selection to maintain a satisfactory quality of service (QoS). Unsynchronized transmissions cause high UL interference and thus degrade the system performance. Thus, a fast timing adjustment mechanism for synchronizing transmission immediately after handover would be advantageous for LTE.

Because there is no dedicated channel established in an LTE system, only shared channels are to be used, which makes it difficult to maintain a tight synchronization. Thus, the handover of the UE 110 to a new cell/Node-B has to be performed using other channels such as an asynchronous primary RACH (PRACH) to acquire the TA between both cells/Node-Bs. By using the asynchronous PRACH for timing adjustment after handover, the UE 110 has to go through a contention based access procedure in order that the cell/Node-B 105 can successfully detect the PRACH sequence and then signal to the UE 110 the proper TA. This results in an unnecessary delay in establishing shared channel connectivity in the target cell/Node-B. Thus, a responsive timing adjustment mechanism during handover would be advantageous for LTE to avoid the need for asynchronous RACH access procedure that incurs delay, (i.e., a handover “blackout period” is avoided).

It would therefore be advantageous if a procedure existed relating to the timing adjustment for synchronized communications between the UE 110 and the cell/Node-B 105 during a handover process that does not possess the limitations of conventional systems.

### SUMMARY

The present invention is related to a method and system for adjusting UL transmission timing when sending an initial transmission to a target cell/Node-B of an E-UTRAN immediately after handover from a source cell/Node-B of the E-UTRAN. In accordance with one embodiment of the present invention, the UE autonomously computes and applies a TA value based on beacon channel reference signals which are received from the source and target cells/Node-Bs and knowledge of the relative time difference, (if any), between the source and target cells/Node-Bs. In another embodiment, the UE sends a scheduling request message or real data packets with the computed TA value applied to the UL transmission timing to an E-UTRAN via pre-allocated non-contention based UL radio resources which are negotiated and reserved from the target cell/Node-B to the source cell/Node-B in advance of handover. In an alternative embodiment, the UE sends a scheduling request message with the new computed TA value applied to the UL transmission timing to an E-UTRAN via a synchronous RACH. Then, the E-UTRAN computes a refined, (i.e., more accurate), TA value in response to the scheduling request message and, if necessary, the E-UTRAN signals the refined TA value to the UE, and assigns UL and/or downlink (DL) radio resources to be used in the target cell/Node-B for the UE. If the refined TA value is signaled, the UE initiates data transmission using the refined TA value and the assigned radio resources after the EUTRAN signaling in the target cell is processed.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional wireless communication system which includes at least one Node-B that communicates with at least one UE;

FIG. 2 shows a wireless communication system including a UE and a E-UTRAN with source and target cells/Node-Bs in accordance with the present invention;

FIG. 3 is a flow diagram of an autonomous timing advance LTE handover procedure implemented in the system of FIG. 2 by accessing a target cell/Node-B using pre-allocated radio resources in accordance with one embodiment of the present invention; and

FIG. 4 is a flow diagram of an autonomous timing advance LTE handover procedure implemented in the system of FIG. 2 in which the target cell/Node-B is accessed using synchronous RACH access in accordance with another embodiment of the present invention.

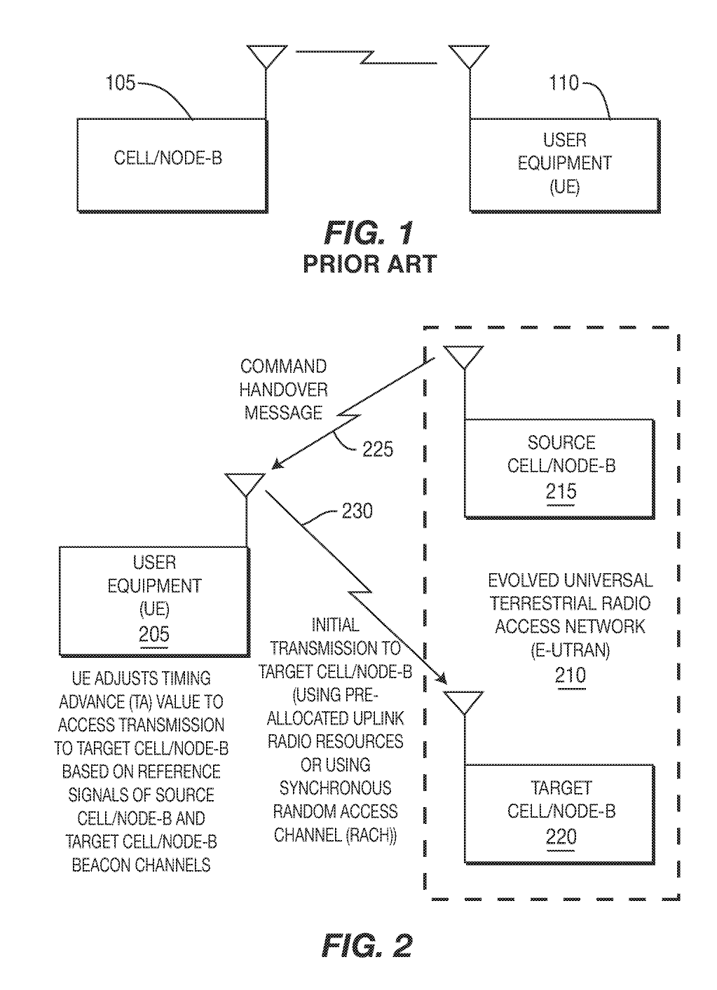

### DETAILED DESCRIPTION OF THE PREFERRED EMBODIMENTS

When referred to hereafter, the terminology “user equipment (UE)” includes but is not limited to a wireless transmit/receive unit (WTRU), a mobile station, a fixed or mobile subscriber unit, a pager, a cellular telephone, a personal digital assistant (PDA), a computer, or any other type of user device capable of operating in a wireless environment.

When referred to hereafter, the terminology “cell/Node-B” includes but is not limited to a cell and/or a Node-B, an LTE eNB, a cell and/or a base station, a site controller, an access point (AP), or any other type of interfacing device capable of operating in a wireless environment.

It should be understood by one of skill in the art that there are different types of handover, such as an intra-Node-B handover and an inter-Node-B handover. In the intra-Node-B handover case, because the handover happens between two cells within one Node-B, a handover occurs from a source cell to a target cell, but the handover is within a common Node-B and does not occur from a source Node-B to a target Node-B. In the inter-Node B handover case, a handover occurs from one cell, (i.e., a source cell), belonging to a source Node-B, to another cell, (i.e., a target cell), belonging to a target Node-B. In this case, the terms “cell” and “Node-B” are interchangeable. A handover from a source cell to a target cell may apply to both cases. When both the source and target cells are supported by a common Node-B it is more likely that these cells may be synchronized with each other.

An application specific integrated circuit (ASIC) may be utilized to implement the present invention. The present invention is applicable to a radio resource management (RRM) and a radio resource controller for a WTRU, base station, network or system, at the physical layer, (digital baseband), or network layer, as software or as a digital signal processor (DSP). The present invention is applicable to the following air interfaces: wideband code division multiple access (WCDMA), frequency division duplex (FDD), CDMA2000 ((Ix Evolution-Data Only (IxEV-DO), Ix Evolution data and voice (IxEV-DV), CDMA, enhanced UL, high speed downlink packet access (HSDPA), and LTE based systems.

The present invention is related to an LTE_Active state, for both intra/inter-Node-B handover cases. The present invention provides a method and procedure by which a UE can autonomously measure and calculate a TA value so that the synchronous transmission can be immediately applied in the target cell following handover. Thus, application of the asynchronous PRACH procedure in the target cell to update the TA value can be avoided.

During a non-handover situation, a TA value is determined by the E-UTRAN from the UL transmissions, and a TA adjustment value is signaled to the UE when necessary. When handover from a source, (i.e., current), cell/Node-B to a target, (i.e., new), cell/Node-B occurs, the UE can autonomously determine the TA value for starting transmissions in the target cell/Node-B, using either pre-allocated UL non-contention based radio resources or a synchronous RACH for access to the target cell/Node-B. Otherwise, if the TA is not adjusted for the target cell, no TA value is applied in the target cell/Node-B and the asynchronous PRACH procedure must be used for the first transmission in the target cell.

If absolute TA signaling is applied, the E-UTRAN must always know the applied TA value in the UE. When a new calculated TA is autonomously determined by the UE, the UE must report the TA after the autonomous adjustment. It is also possible for the E-UTRAN to request the applied TA in a measurement report. Once handover is complete, the nominal TA procedure applies again. If relative TA signaling is applied, it is not necessary to signal the new calculated TA to the E-UTRAN following autonomous TA adjustments by the UE.

In accordance with the present invention, a handover refers specifically to a hard handover between synchronous cells/Node-Bs or between cells/Node-Bs where the relative time difference is known. The present invention provides a UE autonomous TA measurement and calculation method, as well as a procedure for LTE handover to achieve synchronous communication with reduced delay and less interference. The knowledge of the relative time difference (if any) between the source and target cells/Node-B should be signaled to the UE in order to compute a new TA value. In a preferred embodiment the relative time difference or indication that the cells are synchronized with each other is signaled in the handover command.

Depending on which TA information element (IE) in a radio resource control (RRC) command is enabled, either the pre-allocated UL non-contention based radio resource from a target cell/Node-B, or the synchronous RACH, will be used during the handover process to access the target cell/Node-B. Optionally, the E-UTRAN determines which one of the two access functions will be used. The UE calculates the timing difference from the source and target cells/Node-Bs by measuring reference signals on beacon channels received from different cells/Node-Bs. The UE then autonomously determines the TA to apply in UL transmission to a new target cell/Node-B upon handover to avoid the asynchronous PRACH procedure requirement. The UE can use an assigned UL channel with TA applied for direct transmission for a resource request, or it can use a synchronous RACH for a resource request and then start data transmission after radio resource allocation from the target cell/Node-B is completed. When the E-UTRAN directs the UE to handover to a new target cell/Node-B, the E-UTRAN will direct the UE to apply the computed TA in the new cell/Node-B. At all other times, it is the E-UTRAN that determines the TA value. This avoids the need for requiring an asynchronous RACH access procedure to a target cell/Node-B, or a source cell/Node-B SFN-SFN reporting associated with the E-UTRAN handover command.

FIG. 2 shows a wireless communication system 200 including a UE 205 and an E-UTRAN 210 in accordance with the present invention. The E-UTRAN 210 includes a source cell/Node-B 215 and a target cell/Node-B 220.

UE Autonomous TA Measurement During LTE Handover

If the UE 205 performs autonomous TA during handover, it must determine the value of its one-way propagation delay. Let L denote the radio frame length, tᵢ denote the clock time at the cell/Node-B i, pᵢ denote the one-way propagation delay from the cell/Node-B i to the UE 205, and ( )L denote the module operation by L. Since, through cell search, the UE 205 only knows the sum of (tᵢ)L and pᵢ for a cell/Node-B i that the UE 205 is not connected to, the UE 205 has to know either (tᵢ)L or pᵢ to solve the other.

Suppose the distance between the UE 205 and the cell/Node-B i is Dᵢ. The coarse DL timing that the UE 205 detects, (in the first cell search step), for the cell/Node-B i, is (tᵢ)L+Pᵢ+τ_{DL}, where τ_{DL} is the multipath that generates a peak for timing detection. The propagation delay pᵢ=Dᵢ/c is therefore not affected by the frequency. The τ_{DL} part depends on both frequency and environment. After refined timing detection, (the second or third step of cell search), at least part of multipath delay can be resolved.

Let \tilde{τ}_{DL} denote the residual multipath delay which is shorter than τ_{DL}. Then, the fine DL timing becomes (tᵢ)L+pᵢ+\tilde{τ}_{DL}. If \tilde{τ}_{DL} is very small, it can be argued that fine DL timing≈(tᵢ)L+pᵢ, which is independent of frequency. It can temporarily be assumed that \tilde{τ}_{DL} is very small in the following analysis.

In order for the UE 205 to align its UL transmission with other UEs at the cell/Node-B i, the UE 205 needs to perform TA by the amount of 2pᵢ. In this way, the UL transmitted signals of the UE 205 are received at the time of RT(i), which is given by:
RT(i)=(tᵢ)_{L}+pᵢ−2pᵢ+pᵢ+τ_{UL}=(tᵢ)_{L}+τ_{UL}, Equation (1)
where τ_{UL} is the maximum multipath delay in the UL and depends on frequency as well.

A cyclic period (CP) is used in an OFDMA system to avoid inter-timeslot interference. Thus, it functions as a guard period. The use of a CP, (that covers the length of τ_{UL}), ensures that the UL receives signals from UEs which are aligned in time and keeps the orthogonality among them.

According to the preferred embodiment, there are two options to realize a TA calculation at the UE 205.

In one option, if the source and target cells/Node-Bs 215 and 220 in the E-UTRAN 210 are not synchronized, (so far it is the assumption in LTE), the source cell/Node-B i signals the UE 205 the clock difference module by frame length, (i.e., (tⱼ-tᵢ)_{L}), between the source cell/Node-B i and the target cell/Node-B j when the cell/Node-B i signals the UE to handover to the target cell/Node-B j. By knowing (tⱼ)_{L}, pⱼ is solved. If the cells/Node-Bs 215 and 220 are synchronized, then (tᵢ)_{L}=(tⱼ)_{L}. The TA is solved as well.

In another option, the UE 205 measures signal strength of the reference signals (pilots), synchronization channels (SCH) or other DL channels. Based on the measurement, the UE 205 determines its distance from the target cell/Node-B 220 in the E-UTRAN 210 and computes the propagation delay. However, usually it is known that distance can not be accurately and reliably derived from signal strength or path loss measurement. Signal strength fluctuates with fading, which can be mitigated, (however, not eliminated), by collecting measurements over a long time interval.

In order to calculate the TA adjustment, the UE must be signaled either the relative time difference between the source and target cells/node-Bs, or must be informed that the cells are synchronized.

UE Autonomous TA Procedure in LTE Handover

A UE autonomous TA procedure is initiated upon reception of a handover command from the E-UTRAN 210, or fast cell selection coordinated between the UE 205 and the source and target cells/Node-Bs 215 and 220. The UE 205 detects the time difference in reception of the reference signal from beacon channels of the source and target cells/Node-Bs 215 and 220. The time offset is added to the last TA value in the source cell/Node-B 215 upon handover to the target cell/Node-B 220.

Referring to FIG. 2, the UE 205 uses a reference signal from a beacon channel of the source cell/Node-B 215 and a reference signal of a beacon channel of the target cell/Node-B 220 to infer the difference in range between the UE 205 and the source and target cells/Node-Bs 215 and 220. The reference signals may be any type of signal with reference characteristics. The UE 205 is then able to autonomously determine the amount of TA to apply to the target cell/Node-B 220 upon handover by adjusting the source cell TA by the relative difference between the source and target cell reference signals. The beacon channel may be a broadcast channel, a synchronization channel (SCH), and the like.

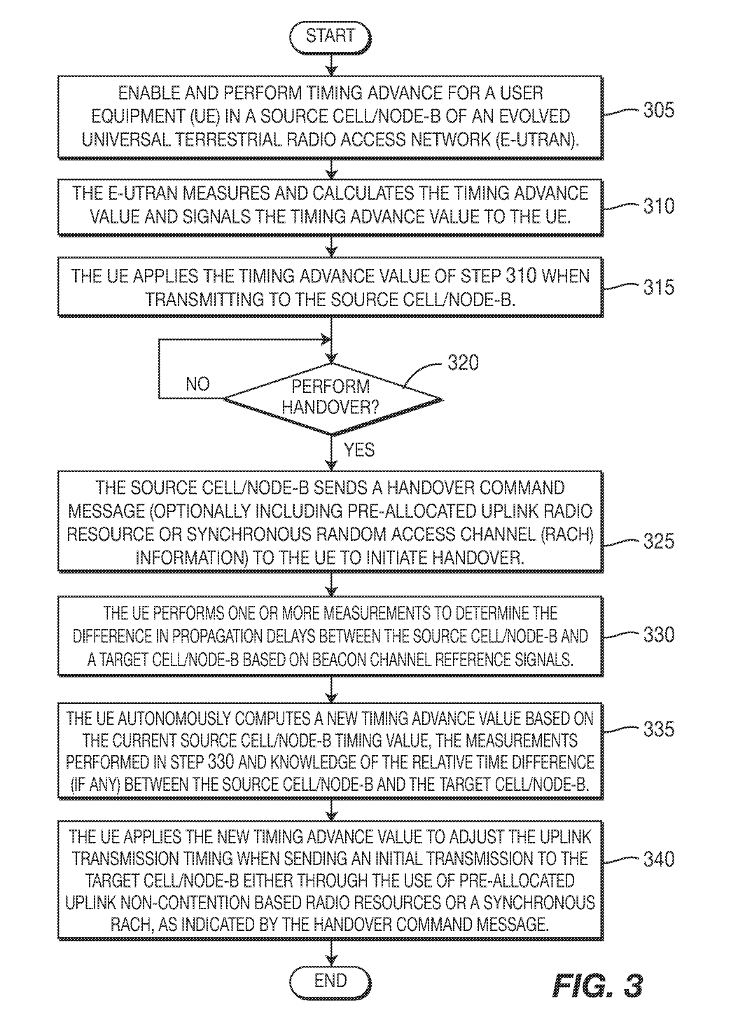

FIG. 3 is a flow diagram of a UE autonomous TA LTE handover procedure 300 implemented in the system 200 of FIG. 2 in accordance with the present invention. In step 305, TA for the UE 205 is enabled and performed in the source cell/Node-B 215 of the E-UTRAN 210. This is enabled by RRC signaling from the network (E-UTRAN) side. In step 310, the E-UTRAN measures and calculates the TA value and signals the TA value to the UE 205. In step 315, the UE 205 applies the TA value of step 310 when transmitting to the source cell/Node-B 215. By using this TA value, the UE 205 is able to adjust its UL transmission timing. In step 320, the E-UTRAN 210 determines when it is time to perform a handover from the source cell/Node-B 215 to the target cell/Node-B 220. When the E-UTRAN 210 determines that a handover is to be performed in step 320, the source cell/Node-B 215 of the E-UTRAN 210 sends a handover command message 225, (i.e., RRC signaling), to the UE 205 to initiate handover of the UE 205 (step 325). The handover command message 225 includes an indication of the relative time difference between the source and target cells or an indication that the cells are synchronized, and may include pre-allocated UL radio resource information which is used to establish initial transmission 230 to the target cell/Node-B 220. The autonomous TA procedure can be explicitly or implicitly inferred from the handover command message 225. The handover command message enables an initial transmission 230 from the UE 205 to the target cell/Node-B 220 to occur during handover, either through the use of pre-allocated UL radio resources from the target cell/Node-B 220 or through the use of a synchronous RACH. When the initial transmission 230 to the target cell/Node-B 220 uses pre-allocated UL radio resources, information regarding the pre-allocated UL radio resources is contained inside the handover command message 225. This RRC signaling may also indicate that a different non-UE autonomous TA measurement approach should be used during handover. In this case, the RRC signaling must also explicitly or implicitly specify if no UE autonomous TA adjustment process is required.

Still referring to FIGS. 2 and 3, in step 330, the UE 205 performs one or more measurements to determine the difference in propagation delays between the source cell/Node-B 215 and the target cell/Node-B 220 based on reference signals transmitted on beacon channels of the source cell/Node-B 215 and the target cell/Node-B 220. In step 335, the UE 205 autonomously computes a new TA value based on the current source cell TA value, the measurements performed in step 330, and knowledge of the relative time difference between the source cell/Node-B 215 and the target cell/Node-B 220 or knowledge that the source cell/Node-B 215 and the target cell/Node-B 220 are synchronized, (i.e., there is no significant relative timing difference between the source cell/Node-B 215 and the target cell/Node-B 220). In step 340, the UE applies the new TA value to adjust the UL transmission timing when sending an initial transmission 230 to the target cell/Node-B 220 using either pre-allocated uplink non-contention based radio resources or a synchronous RACH, as directed by the handover command message 225.

There are two options to use pre-allocated UL radio resource information to access the target cell/Node-B 220 during handover. One option for the UE 205 is to use the pre-allocated UL radio resource by sending a resource request message and/or traffic data to the target cell/Node-B 220. In this case, the target cell/Node-B 220 must respond to the UE 205 with the newly allocated radio resource and if necessary a refined TA value for supporting its subsequent data transmission 230 to the target cell/Node-B 220. The other option is to use the pre-allocated UL radio resource included in the handover command message for direct data transmission. For the above two options, the amount of the pre-allocated radio resource will be different for different purposes that is to be used during handover. The selected option is signaled from the E-UTRAN 210 to the UE 205 inside the DL RRC signaling, during call setup, or inside the handover command message 225 as described above. In doing so, the adjustment of UL transmission timing synchronization to the target cell/Node-B 220 may be achieved immediately after the handover, without requiring an asynchronous RACH access procedure.

Optionally, in the case absolute TA values are used, it is necessary for the UE 205 to report the autonomously computed TA value to the target cell/Node-B 220 when sending the initial transmission 230 to the target cell/Node-B 220. The UE 205 is not required to inform the target cell/Node-B 220 exactly what the new TA value is in the case relative TA value signaling is applied.

Synchronous RACH Access Procedure During LTE Handover

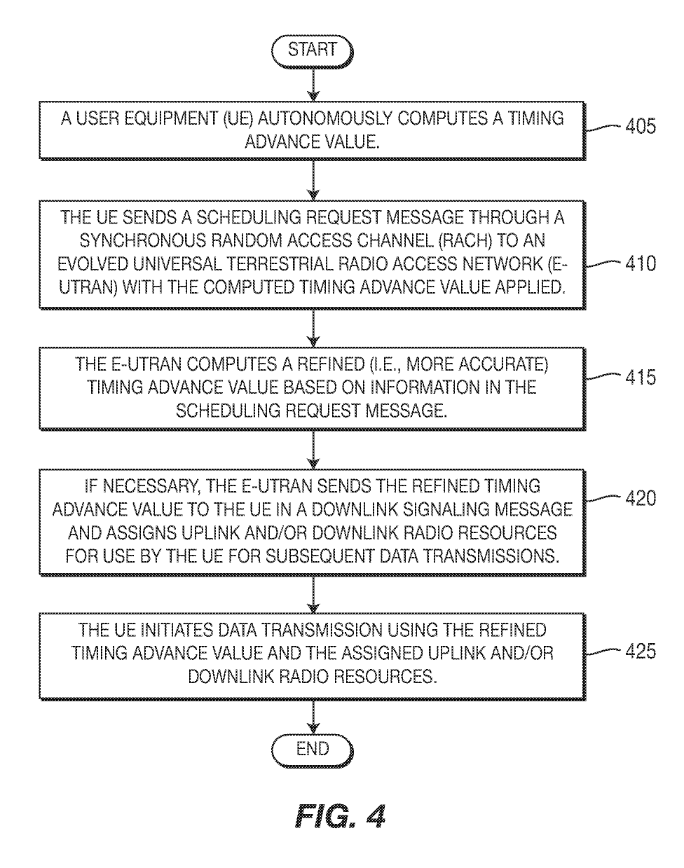

FIG. 4 is a flow diagram of a synchronous RACH access LTE handover procedure 400 in accordance with another embodiment of the present invention. After the UE autonomously computes the timing advance value (step 405), the UE sends a scheduling, (i.e., resource), request message through a synchronous RACH channel to the E-UTRAN 210 with the computed TA value applied (step 410). In step 415, the E-UTRAN 210 computes a refined, (i.e., more accurate), TA value based on information in the scheduling request message received from the UE 205. If necessary, the the E-UTRAN 210 sends the refined TA value to the UE 205 in a DL signaling message, and assigns UL and/or DL radio resources for the UE 205 for subsequent data transmissions (step 420). In step 425, the UE 205 initiates data transmission by using the refined TA value and the assigned UL/DL radio resources.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), a terminal, a base station, a radio network controller, or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless communication system comprising:
at least one user equipment (UE); and
an evolved universal terrestrial radio access network (E-UTRAN) comprising:
a source cell/Node-B which sends a handover command message to the UE when the E-UTRAN determines it is time to perform a handover; and
a target cell/Node-B, wherein the UE adjusts uplink transmission timing when sending an initial transmission to the target cell/Node-B immediately after handover based on information included in the command handover message.

2. The system of claim 1 wherein the handover command message indicates that a UE autonomous timing advance measurement is to be performed during handover.

3. The system of claim 2 wherein the handover command message further indicates a time difference between the source cell/Node-B and the target cell/Node-B.

4. The system of claim 2 wherein the handover command message further indicates that that the source cell/Node-B and the target cell/Node-B are synchronized.

5. The system of claim 1 wherein the handover command message indicates whether the UE should access the target cell/Node-B via at least one pre-allocated non-contention based radio resource in the target cell/Node-B.

6. The system of claim 1 wherein the handover command message indicates whether the UE should access the target cell/Node-B via a synchronous random access channel (RACH) with an applied timing advance value autonomously computed by the UE.

7. The system of claim 1 wherein the handover command message includes pre-allocated uplink non-contention based radio resource information.

8. The system of claim 7 wherein the handover command message indicates whether at least one pre-allocated uplink non-contention based radio resource will be used for a resource request or direct data transmissions to the target cell/Node-B.

9. The system of claim 7 wherein the handover command message indicates an amount of pre-allocated uplink non-contention based radio resources and the life-span of the radio resources.

10. The system of claim 1 wherein when the UE receives the handover command message, the UE performs one or more measurements to determine a difference in propagation delays between the source cell/Node-B and the target cell/Node-B.

11. The system of claim 10 wherein the measurements are performed on beacon channel reference signals of the source cell/Node-B and the target cell/Node-B.

12. The system of claim 11 wherein each beacon channel reference signal is comprised by a synchronization channel (SCH).

13. The system of claim 1 wherein the UE performs one or more measurements to determine a difference in a first significant path between the source cell/Node-B and the target cell/Node-B.

14. The system of claim 1 wherein the UE autonomously computes a timing advance value to adjust the uplink transmission timing.

15. The system of claim 1 wherein the UE uses pre-allocated non-contention based radio resources indicated by the information in the handover command message to adjust the uplink transmission timing.

16. The system of claim 1 wherein radio resource control (RRC) signaling is used to send the handover command message.

17. The system of claim 1 wherein the UE autonomously determines an amount of timing advance to adjust the uplink transmission timing based on reference signals of beacon channels associated with the source cell/Node-B and the target cell/Node-B.

18. The system of claim 17 wherein the UE determines an initial difference in range between the UE and the source and target cells/Node-Bs.

19. The system of claim 1 wherein the UE computes an initial timing advance value and sends a scheduling request message with the computed initial timing advance value through pre-allocated uplink non-contention based radio resources.

20. The system of claim 1 wherein the UE computes an initial timing advance value and sends a scheduling request message with the computed initial timing advance value through a synchronous random access channel (RACH) to the E-UTRAN.

21. The system of claim 20 wherein the E-UTRAN computes a refined time advance value that is more accurate than the initial timing advance value in response to receiving the scheduling request message, and the E-UTRAN signals the refined timing advance value and assignment of uplink radio resources to the UE via downlink signaling.

22. The system of claim 20 wherein the E-UTRAN sends the refined timing advance value and assignment of uplink radio resources to the UE via downlink signaling in a radio resource control (RRC) message, or via layer 1 (L1)/layer 2 (L2) signaling.

23. The system of claim 21 wherein the UE sends an initial transmission to the target cell/Node-B using the refined timing advance value and the assigned uplink radio resources.

24. The system of claim 1 wherein the system is a long term evolution (LTE) system.

25. A long term evolution (LTE) handover method which is implemented in a wireless communication system including at least one user equipment (UE) and an evolved universal terrestrial radio access network (E-UTRAN) including a source cell/evolved Node-B (eNB) and a target cell/eNB, the method comprising:
the source cell/eNB sending a handover command message to the UE when the E-UTRAN determines it is time to perform a handover; and
the UE adjusting uplink transmission timing when sending an initial transmission to the target cell/eNB immediately after handover based on information included in the command handover message.

26. The method of claim 25 wherein the handover command message indicates that a UE autonomous timing advance measurement is to be performed during handover.

27. The method of claim 26 wherein the handover command message further indicates a time difference between the source cell/eNB and the target cell/eNB.

28. The system of claim 26 wherein the handover command message further indicates that that the source cell/eNB and the target cell/eNB are synchronized.

29. The method of claim 25 wherein the handover command message indicates whether the UE should access the target cell/eNB via at least one pre-allocated non-contention based radio resource in the target cell/eNB.

30. The method of claim 25 wherein the handover command message indicates whether the UE should access the target cell/eNB via a synchronous random access channel (RACH) with an applied timing advance value autonomously computed by the UE.

31. The method of claim 25 wherein the handover command message includes pre-allocated uplink non-contention based radio resource information.

32. The method of claim 31 wherein the handover command message indicates whether at least one pre-allocated non-contention based uplink radio resource will be used for a resource request or direct data transmissions to the target cell/eNB.

33. The method of claim 31 wherein the handover command message indicates an amount of pre-allocated uplink non-contention based radio resources and the life-span of the radio resources.

34. The method of claim 25 further comprising:
the UE receiving the handover command message; and
the UE performing one or more measurements to determine a difference in propagation delays between the source cell/eNB and the target cell/eNB.

35. The method of claim 34 wherein the measurements are performed on beacon channel reference signals of the source cell/eNB and the target cell/eNB.

36. The method of claim 35 wherein each beacon channel reference signal is comprised by a synchronization channel (SCH).

37. The method of claim 25 further comprising:
the UE performing one or more measurements to determine a difference in a first significant path between the source cell/eNB and the target cell/eNB.

38. The method of claim 25 wherein the UE autonomously computes a timing advance value to adjust the uplink transmission timing.

39. The method of claim 25 wherein the UE uses pre-allocated non-contention based radio resources indicated by the information in the handover command message to adjust the uplink transmission timing.

40. The method of claim 25 wherein radio resource control (RRC) signaling is used to send the handover command message.

41. The method of claim 25 further comprising:
the UE autonomously determining an amount of timing advance to adjust the uplink transmission timing based on reference signals of beacon channels associated with the source cell/eNB and the target cell/eNB.

42. The method of claim 41 further comprising:
the UE determining an initial difference in range between the UE and the source and target cells/eNBs.

43. The method of claim 25 further comprising:
the UE computing an initial timing advance value; and
the UE sending a scheduling request message with the computed initial timing advance value through pre-allocated uplink non-contention based radio resources.

44. The method of claim 25 further comprising:
the UE computing an initial timing advance value; and
the UE sending a scheduling request message with the computed initial timing advance value through a synchronous random access channel (RACH) to the E-UTRAN.

45. The method of claim 44 further comprising:
the E-UTRAN receiving the scheduling request message;
the E-UTRAN computing a refined time advance value that is more accurate than the initial timing advance value; and
the E-UTRAN signaling the refined timing advance value and assignment of uplink radio resources to the UE via downlink signaling.

46. The method of claim 44 wherein the E-UTRAN sends the refined timing advance value and assignment of uplink radio resources to the UE via downlink signaling in a radio resource control (RRC) message, or via layer 1 (L1)/layer 2 (L2) signaling.

47. The method of claim 45 further comprising:
the UE sending an initial transmission to the target cell/eNB using the refined timing advance value and the assigned uplink radio resources.

48. A long term evolution (LTE) handover method which is implemented in a wireless communication system including at least one wireless transmit/receive unit (WTRU) and an evolved universal terrestrial radio access network (E-UTRAN) including a source cell/evolved Node-B (eNB) and a target cell/eNB, the method comprising:
the source cell/eNB sending a handover command message to the WTRU when the E-UTRAN determines it is time to perform a handover;
the WTRU autonomously computing an initial timing advance value;
the WTRU sending a scheduling request message with the computed first timing advance value through a synchronous random access channel (RACH) to the E-UTRAN; and
the E-UTRAN computing a refined time advance value that is more accurate than the initial timing advance value based on information in the scheduling request message.

49. The method of claim 48 further comprising:
the E-UTRAN sending the refined timing advance value to the WTRU in a downlink signaling message;
the E-UTRAN assigning uplink and/or downlink radio resources for use by the UE for subsequent data transmissions; and
the WTRU sending an initial transmission to the target cell/eNB using the refined timing advance value and the assigned uplink and/or downlink radio resources.

50. A wireless communication system comprising:
at least one wireless transmit/receive unit (WTRU); and
an evolved universal terrestrial radio access network (E-UTRAN) including a source cell/evolved Node-B (eNB) and a target cell/eNB, wherein the source cell/eNB sends a handover command message to the WTRU when the E-UTRAN determines it is time to perform a handover, the WTRU autonomously computes an initial timing advance value, the WTRU sends a scheduling request message with the computed first timing advance value through a synchronous random access channel (RACH) to the E-UTRAN, and the E-UTRAN computes a refined time advance value that is more accurate than the initial timing advance value based on information in the scheduling request message.

51. The system of claim 50 wherein the E-UTRAN sends the refined timing advance value to the WTRU in a downlink signaling message, the E-UTRAN assigns uplink and/or downlink radio resources for use by the WTRU for subsequent data transmissions, and the WTRU sends an initial transmission to the target cell/eNB using the refined timing advance value and the assigned uplink and/or downlink radio resources.
